(19) United States
(12) Patent Application Publication
(10) Pub. No.: US 2007/0094693 A1
(43) Pub. Date: Apr. 26, 2007

(54) Home movies

(76) Inventor: Theodoros H. Asimakopoulos, Wheaton, MD (US)

Correspondence Address: Theodoros Asimakopoulos, 3703 Jeffry St, Wheaton, MD, 20906, US

(21) Appl. No.: 11/257,373

(22) Filed: Oct. 24, 2005

(51) Int. Cl. H04N 7/173; H04N 7/20

(52) U.S. Cl. 725/87; 725/86; 725/63

(57) ABSTRACT

New service that allows individual to view new motion pictures that they would not ordinarily be able to view unless going to the movie theater. This new service is made possible through the use of a satellite.

### CROSS REFERENCE TO RELATED APPLICATIONS

Not Applicable

### FIELD OF INVENTION

This invention relates to a new process of viewing new motion pictures through a satellite that you would not be able to view at home by the conventional process of going to the movie theater.

### BACKGROUND OF INVENTION

To ordinarily view new motion pictures, a person would go to a movie theater. With this new service, someone can view a movie from the comfort of his or her own home. This is possible through the use of a satellite.

### SUMMARY OF THE INVENTION

New service that makes possible for an individual to view new motion pictures that they normally would not be able to view at home. This is achieved through the use of a home receiver that processes signals form a satellite in space.

### DETAILED DESCRIPTION OF THE INVENTION

Uplink antenna sends a message to a satellite that is in orbit in space, which than sends signal, to a home receiver satellite. The home receiver dish than captures signal sent from satellite in space. Therefore through this process you are able to view new motion pictures at home rather than going to the movie theaters.

What is claimed:

1. New service that allows individual to view new motion pictures in the comfort of their own home through the use of a satellite. Public can only access new motion pictures by going to the movie theater. It takes four months after new motion picture is introduced in the movie theater for it to become available on dvd. Through new service that involves a home receiving satellite the above mentioned is possible.
